(19) United States
(12) Patent Application Publication
(10) Pub. No.: US 2017/0371410 A1
(43) Pub. Date: Dec. 28, 2017

(54) DYNAMIC VIRTUAL OBJECT INTERACTIONS BY VARIABLE STRENGTH TIES

(71) Applicant: International Business Machines Corporation, Armonk, NY (US)

(72) Inventors: Gregory J. Boss, Saginaw, MI (US); John E. Moore, JR., Brownsburg, IN (US); Sarbajit K. Rakshit, Kolkata (IN)

(21) Appl. No.: 15/194,680

(22) Filed: Jun. 28, 2016

(51) Int. Cl. G06F 3/01; A63F 13/285; A63F 13/537; A63F 9/24; A63F 13/211; A63F 13/54; A63F 13/95; A63F 13/428

(52) U.S. Cl. CPC G06F 3/014; G06F 3/017; A63F 13/95; A63F 13/285; A63F 13/428; A63F 9/24; A63F 13/211; A63F 13/54; A63F 13/537; A63F 2009/245; A63F 2009/247; A63F 2009/2488

(57) ABSTRACT

Embodiments of the present invention provide a method, computer program product, and a computer system for utilizing variable strength ties to dynamically interact with objects in an environment. According to one embodiment, in an environment containing one or more controllable objects and a wearable device with at least one sensor and a variable strength tie projector, a first predetermined gesture is received from a user. Responsive to receiving the first predetermined gesture from the user, a variable strength tie is generated and directed at a first controllable object. Responsive to detecting a user movement by the at least one sensor, the first controllable object is moved proportional to the detected user movement.

### BACKGROUND OF THE INVENTION

The present invention relates generally to the field of interactive gaming, and more particularly to manipulating physical and virtual objects during game play.

Video gaming continually evolves to produce more realistic gameplay interactions between the user and the game. Characters, actions, appearances, are designed to be as close to reality as possible. Graphics, audible sounds and controls continually evolve to further engage the user and attempt to make the game feel real.

### SUMMARY

According to one embodiment of the present invention, a method for controlling an object in an environment is provided. The method may include: in an environment comprising one or more controllable objects and a wearable device comprising at least one sensor and a variable strength tie projector, receiving, by one or more processors, a first predetermined gesture from a user; responsive to receiving the first predetermined gesture from the user, generating, by one or more processors, a variable strength tie directed at a first controllable object; and responsive to detecting a user movement by the at least one sensor, controlling, by one or more processors, a movement of the first controllable object, wherein the movement of the first controllable object is proportional to the detected user movement.

Another embodiment of the present invention provides a computer program product for controlling an object in an environment, based on the method described above.

Another embodiment of the present invention provides a computer system for controlling an object in an environment, based on the method described above.

### BRIEF DESCRIPTION OF THE DRAWINGS

FIG. 1 is a functional block diagram illustrating a data processing environment, in accordance with an embodiment of the present invention;

FIG. 2 is a flow chart illustrating operational steps for interacting with objects in an environment, in accordance with an embodiment of the present invention;

FIG. 3 is an exemplary wearable device, in accordance with an embodiment of the present invention;

FIG. 4A is a virtual gaming room, in accordance with an embodiment of the present invention;

FIG. 4B is an exemplary depiction of a user in a virtual gaming room, in accordance with an embodiment of the present invention; and

FIG. 5 is a block diagram of the internal and external components of a computer system, in accordance with an embodiment of the present invention.

### DETAILED DESCRIPTION

Embodiments of the present invention enhance entertainment systems and/or educational simulations by providing a more realistic user experience. Techniques for providing realistic interactions may include controlling various objects in a system through bodily and/or hand gestures. Such controllable objects may include holographic projection (both two dimensional and three-dimensional), digitally displayed images on one or more displays, physical objects, etc.

The environment is often tailored to the specific targeted audience. For example, different video games, television programs, movies, etc., are specifically marketed to a specific life style, targeted age groups, and the like. For purposes of this disclosure, examples will be based in a gaming environment; however those skilled in the art will appreciate additional applications, for example, teaching, security, etc. For instance, in a teaching environment, an instructor may use the method, computer program product and computer system disclosed herein to interact with physical and virtual objects to teach students how to perform various actions or improved techniques.

Utilizing the gaming environment profile, a user may interact with physical and/or virtual gaming objects. The gaming environment is similar to a head mounted display as it enables a user to experience a graphical environment, whereby a user may enjoy an illusion of presence in the displayed environment. However, embodiments of the present invention utilize an environment which allows a user to explore and interact with a simulated environment. Such environments may depict views from a city street (including walkways, roads, buildings, cars, planes, etc.), a wildlife scenery (including, rivers, mountains, etc.) to one completely fictitious landscape (i.e., post-apocalyptic world, space travel, non-earth based planet, etc.). Additionally, and/or alternatively, the environment may depict an educational classroom setting. In general the environment provides the user(s) with the most realistic experience possible.

Embodiments of the present invention utilize passive and interactive forms of controlling the various objects. A user may actively perform different gestures and/or movements to control both physical and virtual gaming objects. For example, a user can naturally interact with visual and physical objects within the controlled environment. Similarly, a user may perform a passive interaction, by allowing the system to perform without the user having to control any objects.

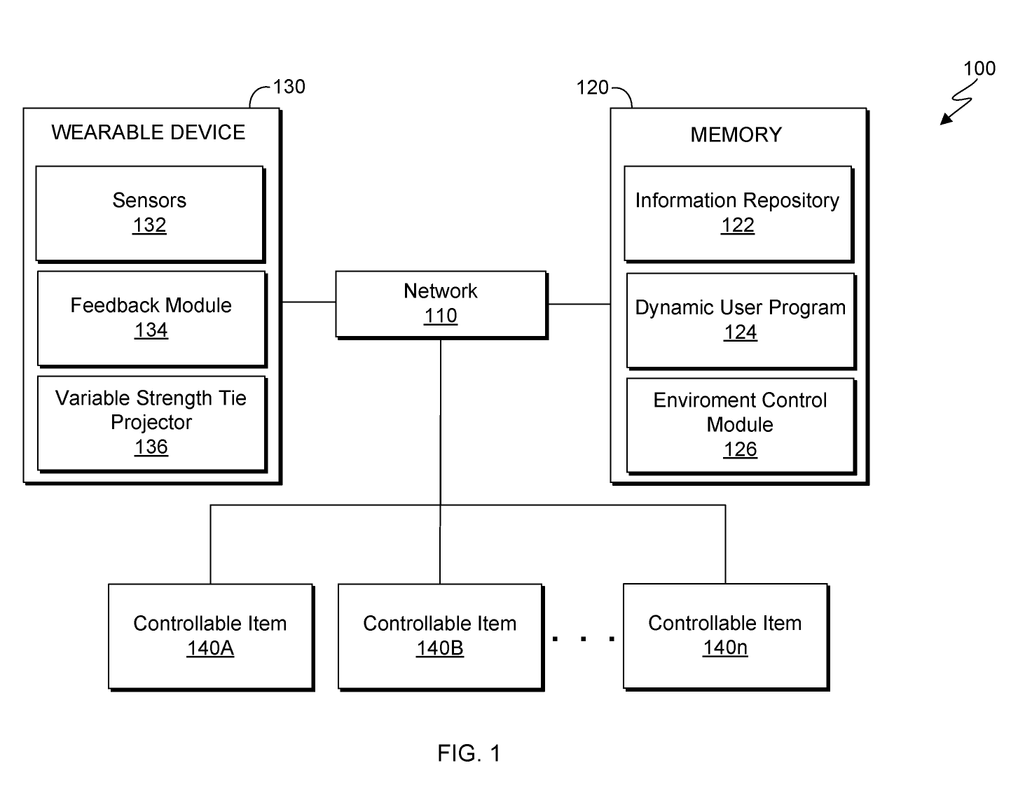

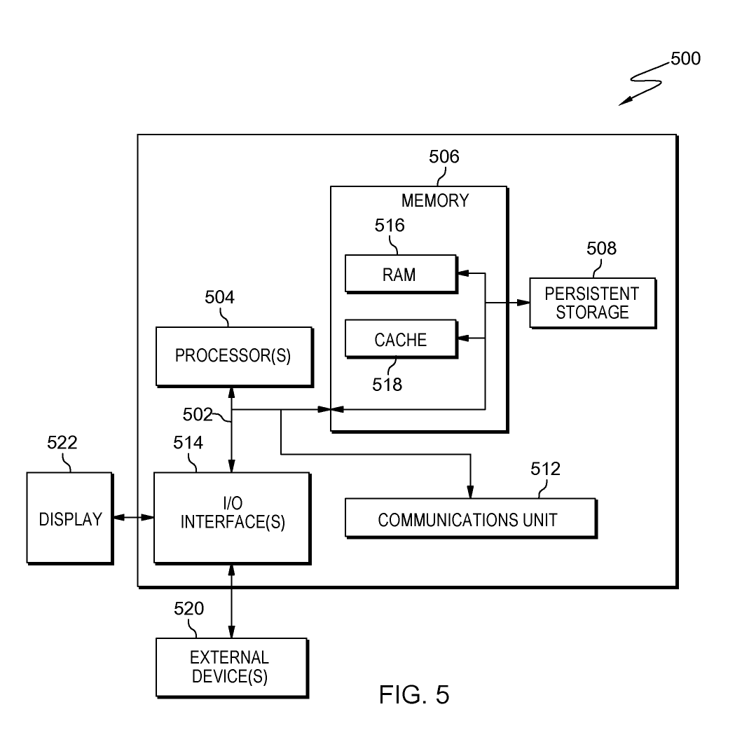

The present invention will now be described in detail with reference to the Figures. FIG. 1 is a functional block diagram illustrating a data processing environment, generally designated 100, in accordance with an embodiment of the present invention. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims. In this exemplary embodiment, environment 100 includes memory 120, wearable device 130, and controllable items 140A through 140n all interconnected over network 110. Memory 120, wearable device 130 and controllable items 140A through 140n and may include internal and external hardware components, as depicted and described in further detail with respect to FIG. 5.

Environment 100 may represent a gaming ecosystem. A gaming ecosystem may have for example (i) projected 3D holographic object in the air; (ii) gaming object(s) displayed on a TV screen; and (iii) physical self-moving gaming objects. For instance, projected 3D holographic object(s) will allow the gaming surroundings to have multiple 3D holographic projectors installed, and the projectors will create a 3D holographic gaming object in the air. Similarly, the physical self-moving gaming object may be a robotic figure, unmanned aerial vehicle (hereinafter ‘UAV’) etc. Through variable strength ties a user may smoothly interact with objects, individually, as one or more distinct groupings and/or all objects collectively. Additionally, the participating devices may interact with each other thereby creating coordination between each object. Such objects are represented by controllable items 140A through 140n.

Network 110 may be a computer network with a small geographic scope. Computer networks with a small geographic scope range from Near Field Communication (NFC) to Local Area Networks (LANs). A computer network with a small geographic scope typically does not have a connection to the Internet or other remote networks. In an alternative embodiment, network 110 is not intended to be limited to a small geographic scope, rather network 110 may include a larger networking environment. For example, network 110 may be used for communication among mobile devices themselves (intrapersonal communication) or for connecting to a higher level network (e.g., the Internet). A wireless personal area network (WPAN) is a network carried over wireless network technologies such as BLUETOOTH® or peer-to-peer communications over a wireless LAN (Bluetooth is a registered trademark of Bluetooth SIG, Inc.). Network 110 architecture may include one or more information distribution network(s) of any type(s), such as, cable, fiber, satellite, telephone, cellular, wireless, etc., and as such, may be configured to have one or more communication channels. In another embodiment, network 110 may represent a “cloud” of computers interconnected by one or more networks, where network 110 is a computing system utilizing clustered computers and components to act as a single pool of seamless resources when accessed.

The various aspects of network 110 are not limited to radio frequency wireless communications; rather, communication may be accomplished via any known mediums in the art, including but not limited to, acoustic mediums, and optical mediums, such as, visible or infrared light. For example, data exchanged between devices, may be transmitted via infrared data links using well known technologies, such as infrared transceivers included in some mobile device models.

Memory 120 includes information repository 122 dynamic user program 124 and environment control module 126. Memory 120 may include any suitable volatile or non-volatile computer readable storage media, and may include random access memory (RAM) and cache memory (not depicted in FIG. 1). Dynamic user program 124 may be stored in a persistent storage component (not depicted) for execution and/or access by one or more of processor(s) via one or more memories of memory 120. Alternatively, or in addition to a magnetic hard disk drive, the persistent storage component can include a solid state hard drive, a semiconductor storage device, read-only memory (ROM), erasable programmable read-only memory (EPROM), flash memory, or any other computer readable storage media that is capable of storing program instructions or digital information.

Information repository 122 can be implemented using any architecture known in the art such as, for example, a relational database, an object-oriented database, and/or one or more tables. Information repository 122 stores actual, modeled, predicted, or otherwise derived patterns of movement based on sensor data. For example, information repository 122 stores all information received from wearable device 130. Information repository 122 may contain lookup tables, databases, charts, graphs, functions, equations, and the like that dynamic user program 124 may access to both maintain a specific parameter as well as manipulate various parameters on controllable item 140A through 140n. Information stored in information repository 122 may include: various user gestures, derived and/or predetermined user patterns, and the like. While depicted on memory 120, in the exemplary embodiment, information repository 122 may be on a server, or a remote server or a “cloud” of computers interconnected by one or more networks utilizing clustered computers and components to act as a single pool of seamless resources, accessible to dynamic user program 124 via network 110.

As embodiments of the present invention provide visual interactivity within the gaming environment, dynamic user program 124 synchronizes the various controllable items 140A through 140n in environment 100 to a user's gestures. During interactive game play, a user interacts with physical and virtual gaming objects through dynamic user program 124. For example, dynamic user program 124 identifies a user gesture and accordingly manipulates the intended physical and/or virtual gaming objects. Dynamic user program 124 allows a user to interact with physical, and virtual objects by identifying physical movements and accordingly manipulates virtual gaming objects plotted in a display device or plotted in air with 3D holographic projections. Similarly, dynamic user program 124 allows a user to interact with physical objects within environment 100 by identifying physical movements and accordingly manipulates any self-controlled gaming objects, like small helicopters, gaming robots etc. For example, a dynamic user program may identify a particular gesture and move a physical or digital image/projection accordingly.

Dynamic user program 124 may analyze sensor data from either information repository 122 and/or sensors 132, to extrapolate and determine users' gestures as to which controllable items 140A through 140n the gesture is directed to and the direction and magnitude of the users' intended movement. After analyzing the data, dynamic user program 124 may move, adjust, control, stop movement, of one or more controllable items 140A through 140n to enhance a user's ability to interact within environment 100. For example, dynamic user program 124 may analyze sensor data and extrapolate which controllable items 140A through 140n is to be controlled and the magnitude of control. It is noted that in this exemplary embodiment, dynamic user program 124 analyzes sensor data, however, in other embodiments, (not shown) a sensor data analyzing module may be an independent feature within environment 100.

Dynamic user program 124 utilizes variable strength ties allowing a user to manipulate and/or interact with physical, digital and virtual objects while in environment 100. Variable strength ties may be projected holographicaly from wearable device to controllable items 140A through 140n. A variable strength tie is a nonphysical connection (virtual) between the user and some object (i.e., controllable items 140A through 140n). For example, the connection may be made between a user's gesture and the desired virtual object. If the gesture is a hand movement, the variable strength tie moves the intended object as a percentage based on a relationship between how much the user's hand moves. For instance, the virtual object would move less the closer the hand is to the object and more the farther away it is. A static strength tie, in contrast, mimics the exact movement of the user, for example, if the user moves their hand two inches, then the object tied to the hand moves two inches (in the same direction).

Dynamic user program 124 may control the movements of controllable items 140A through 140n (i.e., gaming objects) through variable strength ties. Controllable item's 140A movement will be based on the dynamic variable strength ties. For example, based on the direction of pull force with variable strength ties, as determined by sensors 132 in wearable device 130, the gaming objects will move from a digital item displayed on display device to an object projected in 3-D space as a holographic projection.

Dynamic user program 124 will recognize and detect a determined movement. Dynamic user program 124, through sensors 132, may detect a hand gesture, and initiate a variable strength tie projection (via variable strength tie projector 136), thereby connecting user to the intended object. Once the user is connected to the intended object, dynamic user program 124, allows the user to control the object within the rules and configuration of environment control module 126. Therefore, based on a user's gesture and/or movement, dynamic user program 124 may calculate the focus of variable strength ties and accordingly direct the physical object to move.

Dynamic user program 124 may also consider the kinetic inertia of the physical object. For example, when a helicopter is flying, it has a determinable amount of inertia. Therefore, when a user attempts to control the helicopter (or any other physical object), the feedback module 134 may be activated providing haptic feedback, providing user with a sense of resistance. Additionally, dynamic user program 124 may limit the effectiveness of a user's gesture in proposition to the amount of kinetic inertial associated with the physical object. Similarly, dynamic user program 124 may create a simulated amount of kinetic inertia on digital and virtual objects thereby allowing similar feedback when user controls each type of object in the gaming environment.

In an exemplary embodiment, dynamic user program 124 may be preprogrammed to recognize specific gestures and movements and automatically perform the user's intended action. In an exemplary embodiment, dynamic user program 124 may learn various movements and gestures performed by a user and accordingly perform the user's intended action. For example, dynamic user program 124 may derive a pattern based on a user's movements and execute the intended action.

Dynamic user program 124 may be located as depicted in memory 120, however in other embodiments (not shown) dynamic user program 124 may be located on a server. For example, the server may be a management server, a computer server, a web server or any other electronic device capable of receiving and sending data. In another embodiment, server may represent a server computing system utilizing multiple computers as a server system, such as in a cloud computing environment.

Environment control module 126 is a module which controls the overall environmental aspects of environment 100. For example, if the environment is a game, environment control module 126 may be the system which controls the progression of the game and the various rules of the game. For instance, if the game is depicted in space, the environment control module 126 manipulates controllable items 140A through 140n to depict the setting and rules accordingly.

If the environment is an educational setting, environment control module 126 is the system which projects and controls the educational setting. For instance, if the educational setting is space, controllable items 140A through 140n may represent planets. A user may make a predetermined gesture towards controllable items 140A. The gesture towards the planet allowing the user to select a specific planet and pull it towards. This action may move the plant towards user and/or zoom the planet in allowing user to see specific details of the planet. Similarly, a user may make a gesture indicating the planet should rotate along an identified axis. A user may also make another gesture which places the planet back into its original position.

Alternative environments such as moving files and file folders can be utilized by those skilled in the art. Environment control module 126 executes and preforms the overall running of environment 100 with or without a user actively interacting with controllable items 140A through 140n.

In the various embodiments of the present invention, wearable device 130 represents wearable devices. For example, wearable device 130 might be smart watches, capable of detecting various inputs and transmitting data to network 110. Generally, wearable device 130 is wearable and able to detect various movements and/or instructions from the user. In an exemplary embodiment, wearable device 130 is a device worn by a user. Wearable device 130 includes sensors 132, feedback module 134 and variable strength tie projector 136.

Wearable device 130 may be provided in various form factors and may be designed to be worn in a variety of ways. Examples of wearable device 130 include, but are not limited to, a ring, a bracelet, a wristband or a wristwatch. In some embodiments of the present invention, a wearable device 130 is a smart watch. A smart watch is a computerized wristwatch with functionality that is enhanced beyond mere time keeping; rather a smart watch is essentially a wearable computer. Many smart watches can run applications, while others contain additional capabilities, for example, making and receiving phone calls, replacing a traditional smart phone. In other embodiments of the present invention, a wearable device 130 is a wrist band.

In an embodiment, wearable device may include a user interface (not show), allowing the user to override, if necessary dynamic user program 124.

In some embodiments according to the present invention, sensors 132 may have a variety of sensors, including, but not limited to: (i) motion sensors (for example accelerometers and gyroscopes); (ii) acoustic sensors; (iii) infrared images; (iv) thermal images; (v) pressure sensors, (vi) light sensors; and (vii) additional sensors known in the art. Generally, sensors 132 detect information about a user's movement in respect to one or more controllable items 140A through 140n.

Feedback module 134 may provide a user with a plurality of various types of indications. Feedback module 134 may include visual, audio, and/or haptic feedback sensors to display and/or transmit an alert to a user as to various aspects of controlling a physical, digital and/or digital object within environment 100. For example, feedback module 134 communicates to a user via haptic vibrations providing user feedback as to his movements. In another example, feedback module 134 communicates to a user via projecting and/or displaying digital objects in response to a user's commands.

A user may wear a wearable device 130 to interact with controllable items 140A through 140n through variable strength tie projector 136. In an exemplary embodiment, variable strength tie projector 136 may include a 3D holographic laser projector. Based on the user's gesture(s), the variable strength ties may be directed at one or more controllable items 140A through 140n. With appropriate direction and shape of variable strength ties, a user can slow, speed up or move an object within environment 100. Variable strength tie projector 136 may control the movement of physical gaming objects, holographic gaming objects and digital gaming objects.

Variable strength tie projector 136 may project one or more variable strength ties, connecting the user to the controllable items 140A through 140n. Generally, a variable strength tie is a nonphysical connection (virtual) between a user and some virtual object. For example, the connection may be made between a user's gesture and the desired virtual object. If, for example, wearable device 130 is a wristwatch, the variable strength tie virtually connects the user's hands to the controllable item 140A through n. A variable strength tie changes the relationship between how much the user moves and the object moves. If the gesture is a hand movement, the variable strength tie moves the intended object as a percentage based on a relationship between how much the user's hand moves. For example, controllable item 140A would move proportionally to the distance the object is from the user (i.e., the closer the object is to user the more the object will move, or the further way they object is from the user the more it will more, respective to users gesture).

In exemplary environment 100, variable strength tie projector 136 is installed on wearable device 130. However, in alternative embodiments, variable strength tie projector 136 may be located anywhere within the environmental room and connected remotely to wearable device 130. For example dynamic user program 124 may detect a predetermined movement via sensors 132 and activate variable strength tie projector 136 in a similar location and direction as indicated by user.

In the various embodiments of the present invention, controllable items 140A through 140n may represent physical objects (i.e., robots, UAV, etc.); projections via a projector (i.e., digital projectors, 3D holographic image projectors, etc.); and items displayed on display screens; and any other type of object associated with the environment 100. Controllable items 140A through 140n may represent any number of physical or digital objects within environment 100. It is noted that although FIG. 1 depicts controllable items controllable item 140A, controllable item 140B and controllable item 140n, it is to be understood that there can be numerous controllable within environment 100.

Controllable items 140A through 140n may represent virtual gaming objects, physical gaming objects and/or digitally displayed gaming objects. A virtual gaming objects may be plotted in a display device or can be plotted in air with 3D holographic projections etc. A physical gaming objects can be any self-controlled gaming objects, like small UAV's, gaming robots etc. Digitally displayed gaming objects may be depicted on a computer display screen or projector display. In an exemplary embodiment, the various types of gaming objects may simultaneously be active within gaming environment 100.

Controllable items 140A through 140n may be controlled by on various gestures performed by a user. Additionally and/or alternatively, controllable items 140A through 140n may be controlled by the gaming system per the protocols of the environment 100 via environment control module 126. Controllable items 140A through 140n allow for automatic customization by dynamic user program 124. For example, dynamic user program 124 may perform a predetermined gesture and accordingly control the intended object.

Based upon an appropriate direction and shape of the variable strength tie, a user can move controllable items 140A through 140n, regardless of the items physical, digital or holographic nature. Moving controllable items 140A through 140n may include altering the item's current trajectory in any of the X, Y, and Z planes (of the Cartesian coordinate system). Therefore, moving controllable items 140A through 140n also includes the acceleration or deceleration of objects. Hereinafter the deceleration of objects is known as arresting movement.

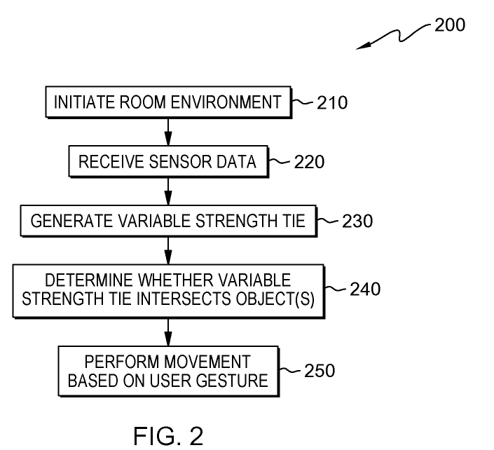

Reference is now made to FIG. 2. FIG. 2 depicts flowchart 200, illustrating the operational steps for interacting with an object in a gaming environment, in accordance with an embodiment of the present invention.

In step 210, dynamic user program 124 initiates the room environment. Initiating the room environment includes activating, linking, and syncing, all controllable items 140A through 140n within the room (also known as the environmental ecosystem). The room is referred to as an environmental ecosystem as it may not be limited to an enclosed area. Rather the room may be a large lecture hall, with appropriate controllable items 140A through 140n. Alternatively, the room may be located outdoors or in a large stadium.

The room may include projectors. Projectors may create 3D objects in the air or project objects on a wall or display board similar to a display screen. If the room comprises multiple projectors, the projectors may communicate with each other allowing the projectors to collectively control movement and dimensions of the projected holographic objects. Controllable items 140A through 140n may represent one or more projected holographic objects. The room may also include one or more display devices. The display devices may display digital objects on the display screens. Controllable items 140A through 140n may represent one or more digital objects displayed on the display screens. The room may also include one or more self-moving physical objects, such as robotic equipment. Controllable items 140A through 140n may represent one or more physical objects. All controllable items 140A through 140n may be in communication with each other and/or in communication with a centralized console such as environment control module 126.

In step 220, dynamic user program 124 receives sensor data from sensors 132 located within wearable device 130. The received sensor data may be a predetermined motion/gesture, and/or derived pattern, to initiate the variable strength tie projector 136.

In step 230, dynamic user program 124 generates at least one variable strength tie projection from variable strength tie projector 136. The holographic variable strength tie projection is projected in a direction interpolated from data received from sensors 132. For example, if wearable device 130 is worn on a user's wrist, and variable strength tie projector 136 is physically attached to wearable device 130, then variable strength tie projection may be projected in the direction the user moves his wrist. For instance, the direction of the variable strength tie may be projected based on the direction of users hand in relation to the projector's direction. In another example, the direction of the variable strength tie projection may be based interpolated data from the one or more sensors 132. Based on the interpolated date, the variable strength tie projection may be projected from wearable device 130 and/or from a projected located remotely in environment 100. The variable strength tie may be generated for any period of time. For example, based on a user's gesture, dynamic user program 124 may generate the variable strength tie as an instantaneous projection, or the projection may last until the user makes a secondary gesture turning off the variable strength tie projection.

In step 240, dynamic user program 124 determines whether the variable strength tie projection intersects any controllable items 140A through 140n. Generally, the variable strength tie is projected away from variable strength tie projector 136 in a fixed trajectory. If the projected variable strength tie is projected for a period of time while the user moves wearable device 130 the trajectory may be altered and moved thought the environment 100. Regardless of the elapsed time variable strength tie is projected, dynamic user program 124 determines if the variable strength tie intersects one or more controllable items 140A through 140n.

Dynamic user program 124 alone or in combination with environment control module 126 is able to determine whether the projected variable strength tie intersects one or more controllable items 140A through 140n. For example, if controllable item 140A is a virtual holographic object, dynamic user program 124 determines whether the variable strength tie crosses the known location of the controllable item 140A, through its known trajectory. Similarly, if controllable item 140A is a physical UAV (controlled by environment control module 126), dynamic user program 124 determines whether the variable strength tie crosses the known location of the UAV, through its known trajectory.

The variable strength tie acts as a nonphysical connection (virtual) between a user and the controllable item 140A. Upon determining an intersection, feedback module 134, may alert the user that the projected variable strength tie has intersected controllable item 140A. Alternatively and/or additionally, each controllable item 140A through n under the one or more projected variable strength ties may change their appearance, color scheme, etc., to notify the user that the controllable item is under the user's control.

In step 250, dynamic user program 124 performs movements of controllable item 140A per the user's guidance. Dynamic user program 124 detects the user's guidance via sensors 132. For example, if the user moves a wearable device up, down, left, right, towards or away from controllable item 140A then dynamic user program 124 accordingly moves controllable item 140A in the intended direction. For instance, if the user applies a pull force (i.e., wearable device is moved towards the user) then dynamic user program 124 accordingly moves controllable item 140A towards the user. In another example, if controllable item 140A is moving left, and the user moves the wearable device in the opposite direction, then controllable item 140A may be slowed and/or stopped. Alternatively, if controllable item 140A is moving left, and the user moves the wearable device in an identical direction, then controllable item 140A may accelerate. The user may sense feedback from feedback module 134, which provides the user a sensation of controlling controllable item 140A.

Dynamic user program 124 may detect an acceleration of the wearable device and apply a relational acceleration force to controllable item 140A. For example, based on the movement of the wearable device, dynamic user program 124 will analyze the concentration of the variable strength tie and accordingly, move controllable item 140A.

Dynamic user program 124 alters the kinetic behavior of controllable item 140A when it is being controlled. For example, dynamic user program 124 may simulate the applied force required to change trajectory and/or movement of any physical or digital objects. For example, based on the simulated weight and movement of controllable item 140A, dynamic user program 124 may respond differently to identical gestures made by a user. A variable strength tie may changes the relationship between how much the user moves wearable device 130 and how much controllable item 140A moves. For instance, controllable item 140A may move less the closer the user is to the controllable item. In the alternative, controllable item 140A may move more the farther away the controllable item is from the user.

Dynamic user program 124 may alter the physical and/or digital appearance of an object. For example, if controllable item 140A is a digital figure displayed on a screen, dynamic user program 124 may move the figure from the screen to a 3D hologram in the air based on the sensed direction of pull force applied to the variable strength tie by the user. In the alternative, a holographic projection may be moved from a figure in space to a figure on a display screen.

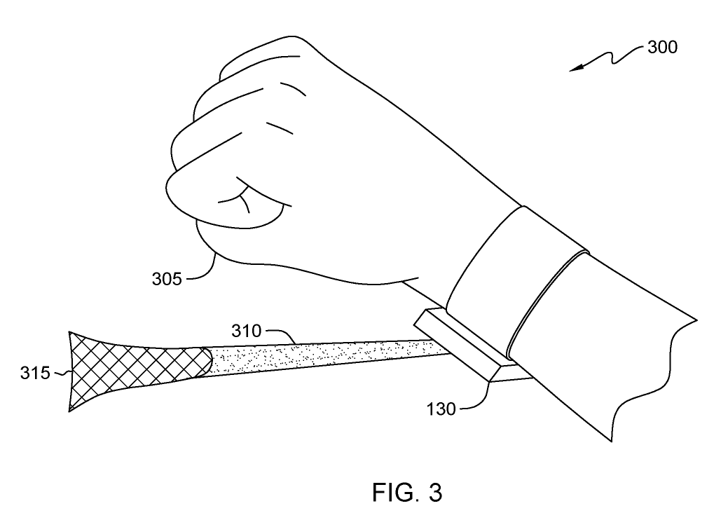

Reference is now made to FIG. 3. FIG. 3 depicts environment 300 in which user 305 is wearing wearable device 130. Wearable device 130 is generating a variable strength tie 310, in accordance with an embodiment of the present invention. FIG. 3 portrays how the holographic variable strength tie may be generated from a smart watch or a wrist wearable device. Based on a predefined finger gesture (or bodily movement), wearable device 130 detects a user's indication and generates a variable strength tie 310. A holographic variable strength tie may be generated in the air in the direction of the user's hand. Variable strength tie 310 may attach itself to controllable item 140A, via a holographic net 315. This allows the user to change the trajectory of controllable item 140A, increase its movement, or slow it down. Using a variable strength tie, the user can arrest a physical, self-moving object or any digital or holographic objects. Thereby, the user may move the selected objects from the current place to a different place, or the physical objects be stopped.

In an embodiment, wearable device 130 may also include a holographic projector (not shown in FIG. 3). The holographic projector may be small enough to fit on wearable device 130. The holographic projector is capable of projecting three-dimensional objects in the air within the environment allowing a user to instruct wearable device 130, via a gesture to project holographic objects.

In an embodiment, wearable device may provide feedback (i.e., haptic, audible, visual, etc.) informing the user that (i) variable strength tie 310 is projected from wearable device 130; (ii) holographic net 315 attaches to one or more controllable items 140A through 140n; and (iii) general feedback creating a realistic sensation when or controlling controllable item 140A.

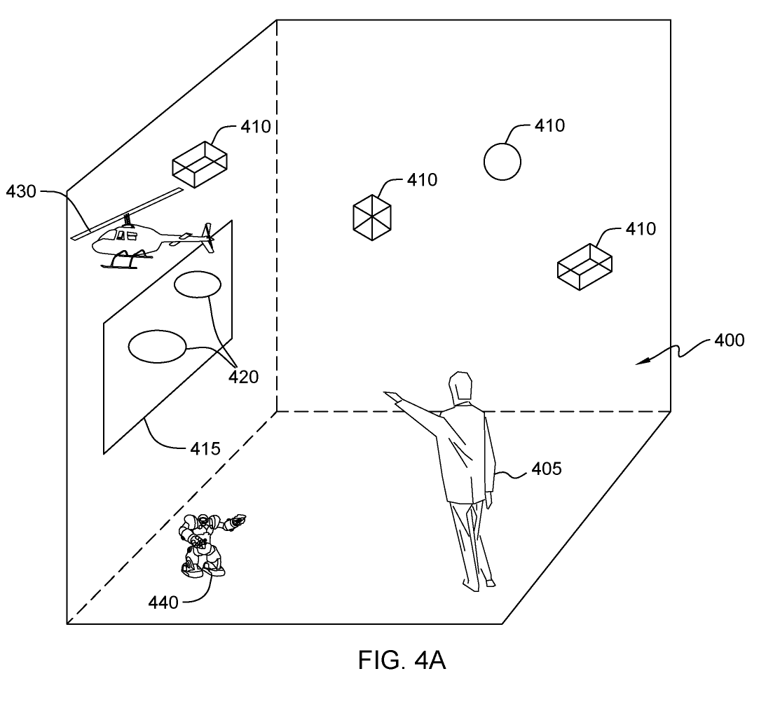

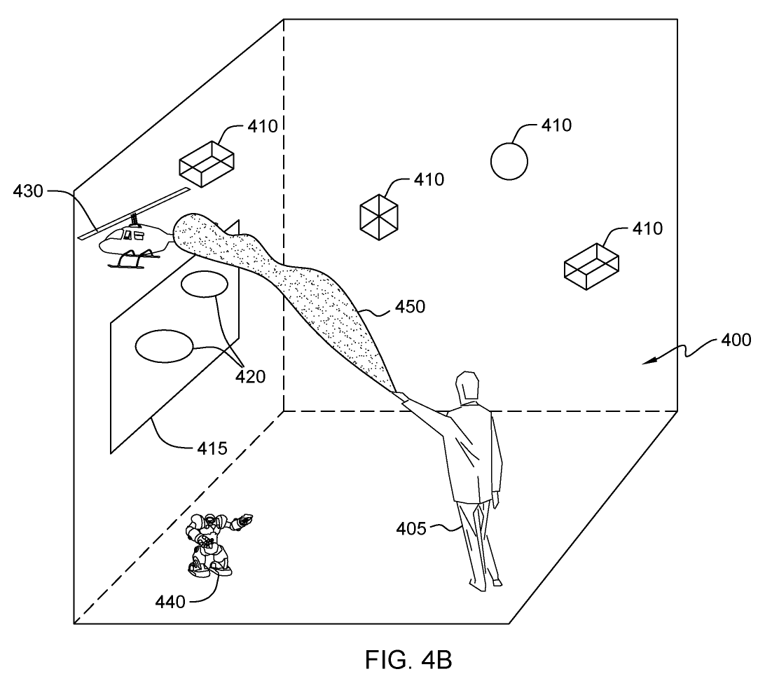

Reference is now made to FIGS. 4A and 4B. FIG. 4A is a virtual gaming room and FIG. 4B is an exemplary depiction of a user in a virtual gaming room controlling movement of controllable item 140A, in accordance with an embodiment of the present invention.

FIG. 4A depicts exemplary gaming environment 400. Gaming environment 400, is exemplary in nature only as other environments may be utilized. Gaming environment 400 depicts user 405 in a room interacting with physical, digital and holographic objects. It is noted that: (i) holographic 3D objects 410 are plotted in the air; (ii) digital objects 420 are plotted in display device 415; and (iii) self-controlled, physical devices objects, i.e., a UAV 430 and a remote control robot 440. All items (holographic, digital, and/or physical) may have programmed instructions on what to do. For example, if the room is to simulate a user traveling through outer space, the items may work together simulating galaxies, asteroids, planets, stars, etc.

Holographic 3D objects 410 may be projected by one or more holographic projects located within the room. Holographic 3D objects 410 are movable throughout the entire space of gaming environment 400. In an embodiment, the gaming room may contain multiple holographic projectors, thereby allowing multiple objects to be created in air, each moving independently as per the gaming logic and/or dynamic user program 124. Similarly, digital objects 420 may be displayed on display device 415. Gaming environment 400 only depicts a single display device 415, however it is understood that there can be any number of display screens positioned throughout the environment. For example, each wall (floor and/or ceiling) may itself be a display screen, thereby providing a more realistic gaming experience for the user. The one or more display devices 415 may be interconnected allowing an object to move from one screen to another. Physical objects, such as UAV 430 and robot 440, as well as other physical objects not shown, may be in gaming environment 400. Physical objects are actual controllable items that may be controlled remotely or wired through the overall system. UAV 430 represents a flying object within the gaming environment. Similarly, robot 440 represents a ground vehicle within the gaming environment. Similar to holographic 3D objects 410 and digital objects 420, physical objects can also be controlled directly by the user via a variable strength tie.

FIG. 4B depicts a user 405 projecting variable strength tie 450 towards UAV 430. Specifically FIG. 4B portrays a user actively using a generated holographic variable strength tie directed towards UAV 430. Once variable strength tie 450 connects to that of UAV 430, user 405 may override the existing program, and/or control UAV 430. For example, user 405 may command UAV 430 to hover in place, or alter its altitude, alter its trajectory, increase its acceleration, and/or decrease its acceleration. In one scenario, if the helicopter is arrested, then gradually the physical object will slow down the speed, and will come downwards with different sound, it will be like a user is pulling down the helicopter. In another scenario, based on the user's movement, UAV 430 may gradually land on the ground. Upon a predetermined gesture, user 405 may disengage variable strength tie 450, allowing UAV 430 to return to being controlled by environment control module 126.

In other embodiments, gaming environment 400 may have two users with separate wearable devices. Each wearable device may communicate with each other and may each generate a variable strength tie to connect to the same controllable item 140A, simultaneously. For example, user A is a student and user B is a teacher, both controlling a UAV 430. User B (the teacher) may have a stronger connection that user A (student) in order to prevent the student from mishandling UAV 430.

In another embodiment, user 405 may have two or more wearable devices 130 on his person simultaneously. This embodiment allows a single user to control two or more controllable items independent of each other.

Reference is now made to FIG. 5. FIG. 5 is a block diagram of internal and external components of a computer system 500, of FIG. 1, in accordance with an embodiment of the present invention. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, wearable computing devices, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 500 includes communications fabric 502, which provides for communications between one or more processors 504, memory 506, persistent storage 508, communications unit 512, and one or more input/output (I/O) interfaces 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 516 and cache memory 518. In general, memory 506 can include any suitable volatile or non-volatile computer readable storage media. Software (e.g., Flexible Bandwidth Program 125) is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer readable storage medium that is also part of persistent storage 508.

Communications unit 512 provides for communications with other computer systems or devices via a network. In this exemplary embodiment, communications unit 512 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to through communications unit 512 (e.g., via the Internet, a local area network or other wide area network). From communications unit 512, the software and data can be loaded onto persistent storage 508.

One or more I/O interfaces 514 allow for input and output of data with other devices that may be connected to computer system 500. For example, I/O interface 514 can provide a connection to one or more external devices 520 such as a keyboard, computer mouse, touch screen, virtual keyboard, touch pad, pointing device, or other human interface devices. External devices 520 can also include portable computer readable storage media such as, for example, thumb drives, portable optical or magnetic disks, and memory cards. I/O interface 514 also connects to display 522.

Display 522 provides a mechanism to display data to a user and can be, for example, a computer monitor. Display 522 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for controlling an object in an environment, the method comprising:
in an environment comprising one or more controllable objects and a wearable device comprising at least one sensor and a variable strength tie projector, receiving, by one or more processors, a first predetermined gesture from a user;
responsive to receiving the first predetermined gesture from the user, generating, by one or more processors, a variable strength tie directed at a first controllable object; and
responsive to detecting a user movement by the at least one sensor, controlling, by one or more processors, a movement of the first controllable object, wherein the movement of the first controllable object is proportional to the detected user movement.

2. The method of claim 1, wherein the one or more controllable objects comprises at least one of the following:
a virtual object, wherein the virtual object is a three dimensional holographic object;
a remote controlled physical object capable of movement within the environment; and
a digital object, wherein the digital object is displayed on a display device.

3. The method of claim 1, further comprising:
alerting, by one or more processors, the user, identifying an operable connection to the first controllable object, wherein the alert comprises at least one of: visual feedback, audio feedback, and haptic feedback.

4. The method of claim 1, wherein controlling the movement of the first controllable object, further comprises:
detecting, by one or more processors, an acceleration generated by the user; and
based on a relational acceleration, altering, by one or more processors, an acceleration of the first controllable object, wherein the relational acceleration changes at least one of a velocity and a direction of the first controllable object respective to the detected acceleration generated by the user.

5. The method of claim 1, further comprising:
determining, by one or more processors, the generated variable strength tie is directed at the first controllable object and a second controllable object; and
responsive to detecting the user movement by the at least one sensor, controlling, by one or more processors, the movement of the first controllable object and the second controllable object, wherein the movement of the first controllable object and the second controllable object are proportional to the detected user movement.

6. The method of claim 2, wherein the one or more controllable objects are configured to transform from: a virtual object to a digital object; and a digital object to a virtual object.

7. The method of claim 1, further comprising:
determining, by one or more processors, a simulated quantity of kinetic inertia of the first controllable object; and
applying, by one or more processors, a restriction force on the first controllable object in a proportional relationship to user movements responsive to detecting user movements by the at least one sensor and the determined simulated quantity of kinetic inertia.

8. A computer program product comprising:
one or more computer readable storage media and program instructions stored on the one or more computer readable storage media, the program instructions comprising:
in an environment comprising one or more controllable objects and a wearable device comprising at least one sensor and a variable strength tie projector, program instructions to receive a first predetermined gesture from a user;
responsive to receiving the first predetermined gesture from the user, program instructions to generate a variable strength tie directed at a first controllable object; and
responsive to detecting a user movement by the at least one sensor, program instructions to control a movement of the first controllable object, wherein the movement of the first controllable object is proportional to the detected user movement.

9. The computer program product of claim 8, wherein the one or more controllable objects comprises at least one of the following:
a virtual object, wherein the virtual object is a three dimensional holographic object;
a remote controlled physical object capable of movement within the environment; and
a digital object, wherein the digital object is displayed on a display device.

10. The computer program product of claim 8, further comprising:
program instructions to alert the user, identifying an operable connection to the first controllable object, wherein the alert comprises at least one of: visual feedback, audio feedback, and haptic feedback.

11. The computer program product of claim 8, wherein the program instructions to control the movement of the first controllable object, further comprise:
program instructions to detect an acceleration generated by the user; and
based on a relational acceleration, program instructions to alter an acceleration of the first controllable object, wherein the relational acceleration changes at least one of a velocity and the direction of the first controllable object respective to the detected acceleration generated by the user.

12. The computer program product of claim 8, further comprising:
program instructions to determine the generated variable strength tie is directed at the first controllable object and a second controllable object; and
responsive to detecting the user movement by the at least one sensor, program instructions to control the movement of the first controllable object and the second controllable object, wherein the movement of the first controllable object and the second controllable object are proportional to the detected user movement.

13. The computer program product of claim 9, wherein the one or more controllable objects are configured to transform from: a virtual object to a digital object; and a digital object to a virtual object.

14. The computer program product of claim 8, further comprising:
program instructions to determine a simulated quantity of kinetic inertia of the first controllable object; and
program instructions to apply a restriction force on the first controllable object in a proportional relationship to user movements responsive to detecting user movements by the at least one sensor and the determined simulated quantity of kinetic inertia.

15. A computer system comprising:
one or more computer processors;
one or more computer readable storage media;
program instructions stored on the one or more computer readable storage media for execution by at least one of the one or more processors, the program instructions comprising:
in an environment comprising one or more controllable objects and a wearable device comprising at least one sensor and a variable strength tie projector, program instructions to receive a first predetermined gesture from a user;
responsive to receiving the first predetermined gesture from the user, program instructions to generate a variable strength tie directed at a first controllable object; and
responsive to detecting a user movement by the at least one sensor, program instructions to control a movement of the first controllable object, wherein the movement of the first controllable object is proportional to the detected user movement.

16. The computer system of claim 15, wherein the one or more controllable objects comprises at least one of the following:
a virtual object, wherein the virtual object is a three dimensional holographic object;
a remote controlled physical object capable of movement within the environment; and
a digital object, wherein the digital object is displayed on a display device.

17. The computer system of claim 15, further comprising:
program instructions to alert the user, identifying an operable connection to the first controllable object, wherein the alert comprises at least one of: visual feedback, audio feedback, and haptic feedback.

18. The computer system of claim 15, wherein the program instructions to control the movement of the first controllable object, further comprise:
program instructions to detect an acceleration generated by the user; and
based on a relational acceleration, program instructions to alter an acceleration of the first controllable object, wherein the relational acceleration changes at least one of a velocity and the direction of the first controllable object respective to the detected acceleration generated by the user.

19. The computer system of claim 16, wherein the one or more controllable objects are configured to transform from: a virtual object to a digital object; and a digital object to a virtual object.

20. The computer system of claim 15, further comprising:
program instructions to determine a simulated quantity of kinetic inertia of the first controllable object; and
program instructions to apply a restriction force on the first controllable object in a proportional relationship to user movements responsive to detecting user movements by the at least one sensor and the determined simulated quantity of kinetic inertia.
